(19) United States
(12) Patent Application Publication
(10) Pub. No.: US 2011/0012381 A1
(43) Pub. Date: Jan. 20, 2011

(54) BUMPER STRUCTURE

(75) Inventors: Shigenori Saito, Tokyo (JP); Yasutoshi Shimano, Tokyo (JP); Ji Li, Shizuoka (JP); Kazuhiro Noguchi, Tokyo (JP); Katsu Nakajima, Tokyo (JP)

Correspondence Address: MERCHANT & GOULD PC, P.O. BOX 2903, MINNEAPOLIS, MN, 55402-0903, US

(73) Assignees: NIKKEIKIN ALUMINUM CORE TECHNOLOGY COMPANY LTD., Shinagawa-ku ,Tokyo (JP); NIPPON LIGHT METAL COMPANY, LTD., Shinagawa-ku,Tokyo (JP)

(21) Appl. No.: 12/921,105

(22) PCT Filed: Mar. 3, 2009
(86) PCT No.: PCT/JP2009/053953

§ 371 Date: Sep. 3, 2010

(30) Foreign Application Priority Data
Mar. 5, 2008 (JP) 2008-055448 2008

(51) Int. Cl. B60R 19/34

(52) U.S. Cl. 293/133

(57) ABSTRACT

A lightweight bumper structure is achieved without a reduction in the amount of absorption of collision energy. A bumper structure (B1) is provided with a left and right pair of bumper stays (1, 1) fixed to side members (S), and also with a bumper reinforcing member (2) supported by both the bumper stays (1, 1). Each bumper stay (1) is formed in a shape the width of which gradually increases from the side member (S) toward the bumper reinforcing member (2). The bumper reinforcing member (2) is curved between both the bumper stays (1, 1). The rigidity of the bumper stays (1) and the bumper reinforcing member (2) is set so that the bumper stays (1) are crushed in the front-rear direction after the curved portion of the bumper reinforcing member (2) is rectilinearly extended.

### BACKGROUND OF THE INVENTION

1. Field of the Invention

The present invention relates to a bumper structure including a bumper reinforcing member and bumper stays.

2. Description of the Related Art

A bumper structure including a bumper reinforcing member having a bent portion and bumper stays supporting the bumper reinforcing member is known, in which the reinforcing member is crushed in a front-rear direction after the bent portion of the bumper reinforcing member is rectilinearly extended (see WO2007/110938). According to this bumper structure, it is possible to increase the amount of absorption of collision energy while lowering the peak of crushing load, which results in reducing the damage on a vehicle body while preventing malfunctions of safety apparatus such as an air-bag in a case of light collision.

In addition, another bumper structure provided with a bumper stay including a hollow member formed in a shape widening toward the end (formed in a shape the width of which gradually increases from a side member toward the bumper reinforcing member) is also known (see Japanese Patent Application Laid-open Nos. 2003-312399 and 2004-182139). Using a bumper stay formed in a shape widening toward the end, it is possible to increase the crushing area of the bumper reinforcing member, resulting in an increase in the amount of absorption of collision energy.

In this description, a process in which a bent portion or a curved portion of the bumper reinforcing member is extended rectilinearly is called “extension process”, a process in which the bumper reinforcing member is crushed in a front-rear direction is called “cross-section crushing process”, and a process in which the bumper stay is crushed in a front-rear direction is called “stay crushing process”.

The bumper reinforcing member described in WO2007/110938 is formed of a hollow member. For saving the weight of such a bumper reinforcing member, it is effective to reduce the wall thickness of the hollow member. However, reducing the wall thickness of the bumper reinforcing member causes a reduction of the second moment of area, and a deformation resistance of the bumper reinforcing member in extending the bent portion to straight becomes small. As a result, collision energy absorbed in the extension process also becomes small. That means, reducing the wall thickness of the bumper reinforcing member for weight saving does not meet the need to increase the amount of absorption of collision energy.

If the offset distance between the right and left bumper stays (i.e. the distance between the supporting points of the bumper reinforcing member) is narrowed, it may be possible to make the bumper reinforcing member thin-walled or lightweight without reducing the amount of absorption of collision energy during the extension process. However, it is extremely difficult to change the mounting locations of the bumper stays fixed on the side member, and not practical.

In the bumper structure disclosed in JP2003-312399 and JP2004-182139, the distance between the supporting points of the bumper reinforcing member appears to be narrowed owing to the existence of bumper stays having a shape widening toward the end. However, in the bumper stay disclosed in JP2003-312399 or JP2004-182139, sidewall having a shape widening toward the end and located inside in a vehicle width direction buckles in the early phase of a collision, and therefore it is not regarded as taking a roll of enhancing the deformation resistance of the bumper reinforcing member. In other words, even in the bumper structure disclosed in JP2003-312399 or JP2004-182139, reducing the wall thickness for the purpose of weight saving of the bumper reinforcing member also reduces the amount of absorption of collision energy.

### SUMMARY OF THE INVENTION

In light of the problems above, an object of the present invention is to provide a lightweight bumper structure without reducing the amount of absorption of collision energy.

The present invention for solving the problems above is, a bumper structure including: a left and right pair of bumper stays fixed to a vehicle body; and a bumper reinforcing member supported by both the bumper stays; wherein each bumper stay is formed in a shape a width of which gradually increase from the vehicle body toward the bumper reinforcing member, the bumper reinforcing member is bent or curved between both the bumper stays, and rigidity of the bumper stays and the bumper reinforcing member is determined so that the bumper stays are crushed in a front-rear direction after a bent portion or a curved portion of the bumper reinforcing member is rectilinearly extended.

According to the present invention, a bumper reinforcing member is supported by bumper stays having a shape widening toward the end. Since the bumper stays are not crushed during an extension process (a process in which a bent portion or a curved portion of the bumper reinforcing member is rectilinearly extended), a distance between the supporting points of the bumper reinforcing member is narrowed not only in appearance but also materially. In other words, according to the present invention, it is possible to reduce a wall thickness of the bumper reinforcing member without a reduction of a deformation resistance of the bumper reinforcing member between the bumper stays, which consequently allows weight saving without a reduction in the amount of absorption of collision energy during the extension process.

In the present invention, if the wall thickness of the bumper reinforcing member is made equivalent to that of a case where the bumper reinforcing member is supported by bumper stays having a constant width, the deformation resistance of the bumper reinforcing member between the bumper stays becomes higher than that of the case when supported by bumper stays having a constant width. Consequently, the amount of absorption of collision energy during the extension process is increased.

In addition, if the bumper stay has a pair of sidewalls facing to each other with a distance in a vehicle width direction, and the offset distance of which gradually increases from the vehicle body toward the bumper reinforcing member, the rigidity of the bumper stays and the bumper reinforcing member may be determined so that the sidewall that is located inside in a vehicle width direction is crushed after a bent portion or a curved portion of the bumper reinforcing member is rectilinearly extended. By determining the rigidity as mentioned above, since the sidewall that is located inside in a vehicle width direction is not buckled during the extension process, a distance between the supporting points of the bumper reinforcing member is narrowed not only in appearance but also materially. In fact, it is possible to reduce a wall thickness of the bumper reinforcing member without a reduction of a deformation resistance of the bumper reinforcing member between the bumper stays, which consequently allows weight saving without a reduction in the amount of absorption of collision energy during the extension process.

The sidewall that is located inside in a vehicle width direction may have a portion curved toward an internal space of the bumper stay. In such a structure, it is possible to guide the buckling mode of the sidewall that is located inside in a vehicle width direction so that the side wall breaks into the internal space of a bumper stay 3, which reduces the variation in the amount of absorption of collision energy when the bumper stay is crushed.

It is preferable, but not necessarily, that the bumper stay is made to have a fixing portion abutting on the bumper reinforcing member and a reinforcing wall extending from the sidewall located inside in the vehicle width direction toward the fixing portion, whereby a hollow space having a triangular shape in a plan view is formed by the sidewall located inside in the vehicle width direction and the fixing portion and the reinforcing wall. In this structure, since the sidewall that is located inside in the vehicle width direction is not deformed easily, the bumper reinforcing member can be supported firmly during the extension process.

In the present invention, the rigidity of the bumper reinforcing member and the bumper stays may be determined so that the bumper stays break into the bumper reinforcing member after a bent portion or a curved portion of the bumper reinforcing member is rectilinearly extended. In this structure, since a peak of collision load that propagates to the vehicle body during an extension process and a peak of collision load (crushing load) that propagates to the vehicle body during a cross-section crushing process (a process in which the bumper reinforcing member is crushed in a front-rear direction) appear in series with time lags, it is possible to keep the collision load by preventing a large reduction thereof after an increase thereof to the vehicle body. In addition, by making the bumper stays that have a shape widening toward the end break into the bumper reinforcing member, a crushing area of the bumper reinforcing member increases, resulting in the increase of the absorption amount of collision energy.

In the present invention, the rigidity of the bumper reinforcing member and the bumper stays may be determined so that the bumper stays are crushed after the bumper stay breaks into the bumper reinforcing member. By determining the rigidity as mentioned above, since a peak of collision load that propagates to the vehicle body during an extension process, a cross-section crushing process, and a stay crushing process (a process in which the bumper stay itself is crushed) appear in series with time lags, it is possible to keep the collision load by preventing a large reduction thereof after an increase thereof.

In addition, if at least one of the bumper reinforcing member and the bumper stay is formed of an extruded member made of aluminum alloy, it is possible to reduce the weight of the bumper structure, to lower the cost, to facilitate the production, and to provide a stable quality.

According to the present invention, a lightweight bumper structure can be achieved without a reduction in the amount of absorption of collision energy.

### BRIEF DESCRIPTION OF THE DRAWINGS

FIG. 1 shows a perspective view of a bumper structure in a first embodiment of the present invention;

FIG. 2A shows an enlarged plan view of the bumper structure in the first embodiment of the present invention; FIG. 2B shows a sectional view when viewed on section line X-X shown in FIG. 2A;

FIG. 3A shows a plan view of the bumper structure before a collision load is applied; FIG. 3B shows a plan view of an extension process; FIG. 3C shows a plan view of a cross-section crushing process; FIG. 3D shows a plan view of a stay crushing process;

FIGS. 4A and 4B show plan views of deformation examples of a bumper stay;

FIG. 5 shows a plan view of a deformation example of a bumper reinforcing member;

FIG. 6A shows an enlarged plan view of a bumper structure in a second embodiment of the present invention; FIG. 6B shows an enlarged plan view for explaining a structure of a sidewall that is located inside in a vehicle width direction;

FIG. 7 shows an enlarged perspective view of the bumper structure in the second embodiment of the present invention;

FIG. 8A shows a plan view of the bumper structure before a collision load is applied; FIG. 8B shows a plan view of an extension process; FIG. 8C shows a plan view of a cross-section crushing process; FIG. 8D shows a plan view of a stay crushing process;

FIG. 9A shows a plan view of a bumper structure in a third embodiment of the present invention; FIG. 9B shows a back view of the same; and

FIG. 10 shows an enlarged plan view of the bumper structure in the third embodiment of the present invention.

### DESCRIPTION OF THE SYMBOLS

B1 bumper structure
1 bumper stay
12,13 sidewall
14 fixing portion
2 bumper reinforcing member
B2 bumper structure
3 bumper stay
32,33 sidewall
34B inside fixing portion (fixing portion)
36 reinforcing wall
4 bumper reinforcing member
B3 bumper structure
5 bumper stay
52,53 sidewall
54B inside fixing portion (fixing portion)
56 reinforcing wall
6 bumper reinforcing member

### DETAILED DESCRIPTION OF THE PREFERRED EMBODIMENTS

### First Embodiment

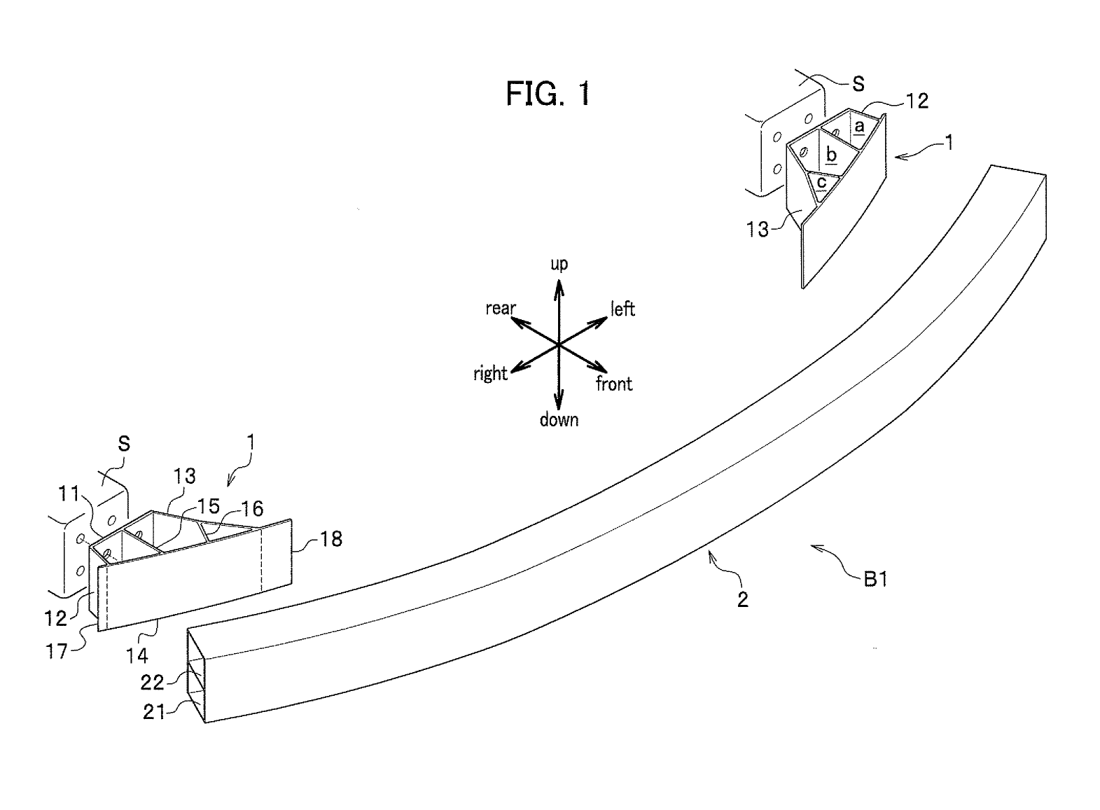

As shown in FIG. 1, a bumper structure B1 in the first embodiment includes a left and right pair of bumper stays 1,1 fixed to side members (vehicle body) S, and a bumper reinforcing member 2 supported by both the bumper stays 1,1. This embodiment shows an example in which the bumper structure B1 forms a front bumper, and terms “front and rear”, “right and left”, and “up and down” are used based on a state the bumper structure is attached to the vehicle body. In addition, a term “vehicle width direction” is used synonymously with “horizontal direction”.

The bumper stay 1 is formed in a shape the width of which gradually increases from the side member S toward the bumper reinforcing member 2 (referred to as “a shape widening toward the end”). The bumper stay 1 in the present invention is formed of a hollow extruded member having three hollow spaces a, b, and c so that the extruding direction is an up and down direction.

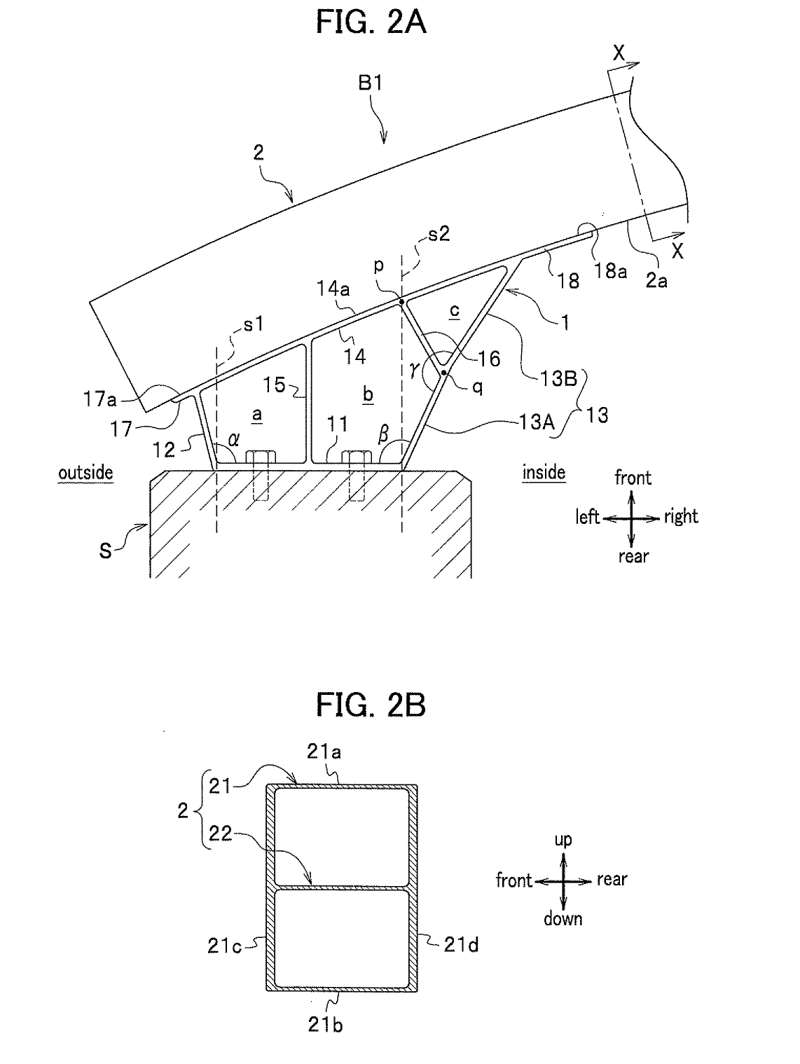

As shown in FIG. 2A, the bumper stay 1 includes a base portion 11, a pair of sidewalls 12,13, a fixing portion 14, a partition wall 15, a reinforcing wall 16, an outside projecting portion 17, and an inside projecting portion 18.

The base portion 11 is a flat plate portion that is to be fixed to an anterior end surface of the side member S. The base portion 11 has a bolt-hole on its appropriate portion through which a bolt is inserted for fixing the base portion 11 to an anterior end surface of the side member S.

The sidewall 12 located outside in a vehicle width direction is a portion extending from an end edge located outside in a vehicle width direction of the base portion 11 to an end edge located outside in a vehicle width direction of the fixing portion 14. The sidewall 13 located inside in a vehicle width direction is a flat plate portion extending from an end edge located inside in a vehicle width direction of the base portion 11 to an end edge located inside in a vehicle width direction of the fixing portion 14. The sidewalls 12, 13 are located so that the partition wall 15 is located therebetween, and facing to each other with a distance in a vehicle width direction (horizontal direction). An offset distance of the sidewalls 12, 13 gradually increases from the side member S toward the bumper reinforcing member 2.

In the following explanations, in a case where the sidewalls 12, 13 are to be distinguished from each other, the sidewall 12 located outside in a vehicle width direction (an end portion of the bumper reinforcing member 2 in the longitudinal direction) may be referred to as “exterior wall 12”, and the sidewall 13 located inside in a vehicle width direction (a middle portion of the bumper reinforcing member 2 in the longitudinal direction) may be referred to as “interior wall 13”.

The exterior wall 12 is located outside in a vehicle width direction of a flat plane s1 which passes an end edge located outside of the base portion 11 and is perpendicular to the base portion 11, and forms a flat plate without a bend in this embodiment. In other words, an inner angle α, which is defined by the base portion 11 and the exterior wall 12, forms a blunt angle. In addition, by adjusting the wall thickness and length of the exterior wall 12, the inner angle α and so forth, it is possible to adjust mainly a crushability of the hollow space a. For example, if the wall thickness of the exterior wall 12 is made larger or the length of the exterior wall 12 is made smaller, the buckling load of the exterior wall 12 becomes larger and the crushability of the hollow space a becomes low. If the wall thickness of the exterior wall 12 is made smaller or the length of the exterior wall 12 is made larger, the buckling load of the exterior wall 12 becomes smaller and the crushability of the hollow space a becomes high.

The interior wall 13 is located inside in a vehicle width direction of a flat plane s2 which passes an end edge located inside of the base portion 11 and is perpendicular to the base portion 11. In other words, an inner angle β, which is defined by the base portion 11 and the interior wall 13, forms a blunt angle. The interior wall 13 in this embodiment is bent at a central portion in a front-rear direction (broken point q). A inner angle γ which is defined by a first flat plate portion 13A located nearer to the base portion 11 than the broken point q and a second flat plate portion 13B located nearer to the bumper reinforcing member 2 than the broken point q is larger than 180-degree. In addition, by adjusting the wall thickness and length of the interior wall 13, the inner angle β, γ, and so forth, it is possible to adjust a crushability of the hollow spaces b and c. For example, if the wall thickness of the interior wall 13 is made larger or the length of the interior wall 13 is made smaller, the buckling load of the interior wall 13 becomes larger and the crushability of the hollow spaces b and c becomes low. If the wall thickness of the interior wall 13 is made smaller or the length of the interior wall 13 is made larger, the buckling load of the interior wall 13 becomes smaller and the crushability of the hollow spaces b and c becomes high.

The fixing portion 14 is a portion fixed to a side surface 2a of the bumper reinforcing member 2. An abutting face 14a of the fixing portion 14 is so formed as to have a curved surface (circular arc surface) the curvature of which is the same as that of the side surface 2a of the bumper reinforcing member 2, and can be fitted to the side surface 2a of the bumper reinforcing member 2 by face-to-face contact.

The partition wall 15 is a portion that connects the base portion 11 and the fixing portion 14. The partition wall 15 takes a role to adjust the crushability of the hollow spaces a and b. For example, if the wall thickness of the partition wall 15 is made larger or the length of the partition wall 15 is made smaller, the buckling load of the partition wall 15 becomes larger and the crushability of the hollow spaces a and b becomes low. If the wall thickness of the partition wall 15 is made smaller or the length of the partition wall 15 is made larger, the buckling load of the partition wall 15 becomes smaller and the crushability of the hollow spaces a and b becomes high. Although the partition wall 15 in this embodiment is constructed vertically to the base portion 11 in a central portion thereof, such a location or a gradient are not limited to this manner.

The reinforcing wall 16 is a portion that connects the interior wall 13 and the fixing portion 14. The reinforcing wall 16 takes a role to raise the buckling strength of the interior wall 13, and to adjust the crushability of the hollow spaces b and c. For example, if the wall thickness of the reinforcing wall 16 is made larger or the length of the reinforcing wall 16 is made smaller, the buckling load of the reinforcing wall 16 becomes larger and therefore the interior wall 13 is not buckled easily and the crushability of the hollow spaces b and c becomes low. If the wall thickness of the reinforcing wall 16 is made smaller or the length of the reinforcing wall 16 is made larger, the buckling load of the reinforcing wall 16 becomes smaller and therefore the interior wall 13 is buckled easily and the crushability of the hollow spaces b and c becomes high. Although the reinforcing wall 16 in this embodiment is constructed so as to bridge the intersection p of the flat plane s2 and the fixing portion 14 and the broken point q of the interior wall 13, and forms a truss structure with the second flat plate portion 13B of the interior wall 13 and the fixing portion 14, such a location of the reinforcing wall 16 and so forth are not limited to this manner.

The outside projecting portion 17 is a portion that extends from a connection of the exterior wall 12 and the fixing portion 14 toward outside in a vehicle width direction (left hand side in FIG. 2A). An abutting face 17a of the outside projecting portion 17 is so formed as to have a curved surface (circular arc surface) the curvature of which is the same as that of the side surface 2a of the bumper reinforcing member 2, and can be fitted to the side surface 2a of the bumper reinforcing member 2 by face-to-face contact.

The inside projecting portion 18 is a portion that extends from a connection of the interior wall 13 and the fixing portion 14 toward inside in a vehicle width direction (right hand side in FIG. 2A). An abutting face 18a of the inside projecting portion 18 is so formed as to have a curved surface (circular arc surface) the curvature of which is the same as that of the side surface 2a of the bumper reinforcing member 2, and can be fitted to the side surface 2a of the bumper reinforcing member 2 by face-to-face contact.

In the bumper stay 1 of this embodiment, the rigidity of each portion (a wall thickness, a section size etc.) is determined so that buckling or plastic bending deformation in the exterior wall 12 and the partition wall 15 occurs after buckling or plastic bending deformation in the interior wall 13 and the reinforcing wall 16 occurs.

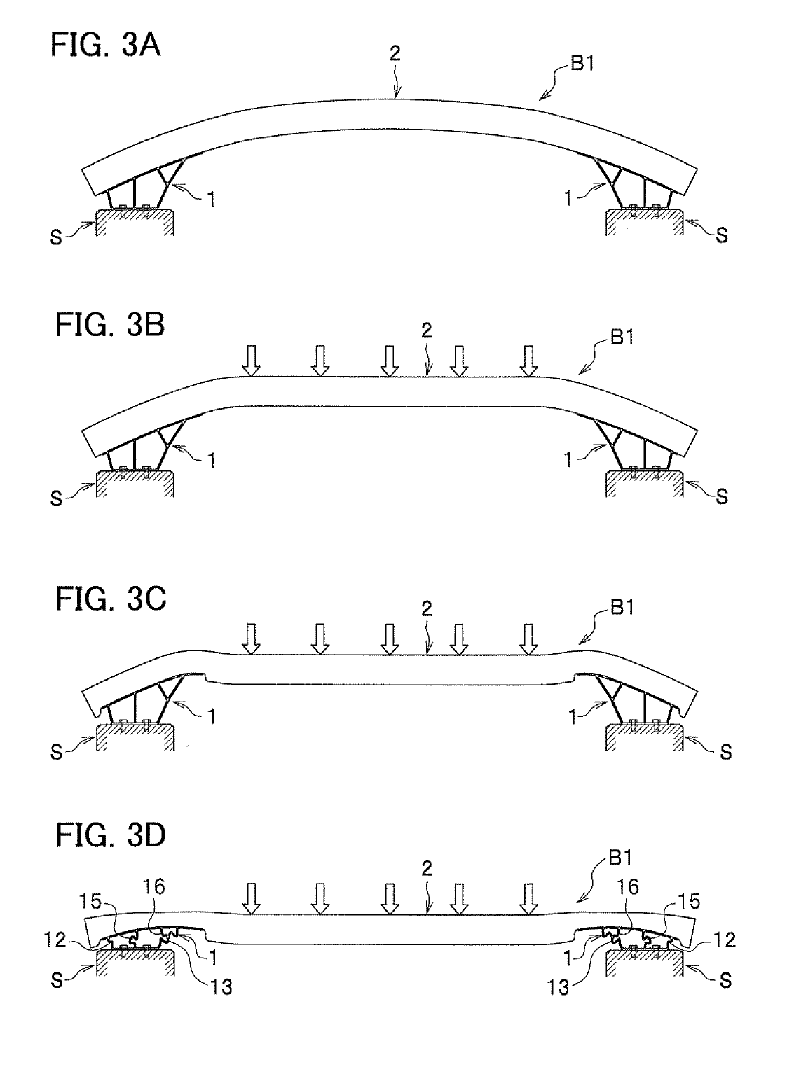

The bumper reinforcing member 2 is a portion that is built on the bumper stays 1, 1, and is fixed to abutting faces 14a, 17a, and 18a of the bumper stay 1 by means of welding or the like. The bumper reinforcing member 2 shown in the figure formed in a shape of circular arc (see FIG. 3A) having both ends extending toward the vehicle body (backward). Such a bumper reinforcing member 2 is achieved by applying a bending work to a hollow extruded member made of aluminum alloy.

As shown in FIG. 2B, the bumper reinforcing member 2 includes a bumper reinforcing member main portion 21 which is an outer shell of the bumper reinforcing member 2, and an inner wall 22 located inside therein. The inner wall 22 is located for the purpose of improving a section stiffness of the bumper reinforcing member 2, and in this embodiment it is located so as to divide an internal space of the bumper reinforcing member main portion 21 into an upper space and a lower space.

The bumper reinforcing member 2 absorbs collision energy during a process in which the curved portion of the bumper reinforcing member 2 is rectilinearly extended between the bumper stays 1, 1 (extension process), and absorbs collision energy during a process in which a buckling or plastic bending deformation occurs on a upper wall 21a, lower wall 21b and inner wall 22 in the area adjacent to the bumper stay 1 (cross-section crushing process). In this embodiment, the bending rigidity of the entire bumper reinforcing member 2 is determined so that the cross-section crushing process makes progress after the extension process makes progress.

Incidentally, the start and end timings of the extension process is mainly affected by the bending rigidity of the entire bumper reinforcing member 2. The bending rigidity is adjusted by an increase or decrease of the second moment of area. Since the second moment of area of the bumper reinforcing member 2 is mainly affected by the wall thickness of the front wall 21c and back wall 21d and the offset distance between the front wall 21c and the back wall 21d, the start and end timings of the extension process can be adjusted by an increase or decrease of these factors. On the other hand, since the start and end timings of the cross-section crushing process is mainly affected by the wall thickness of the upper wall 21a, the lower wall 21b, and the inner wall 22, and the offset distance between the front wall 21c and back wall 21d, therefore the start and end timings of the cross-section crushing process can be adjusted by an increase or decrease of these factors.

In this embodiment, rigidity of the bumper stay 1 and the bumper reinforcing member 2 (a wall thickness and section size of each portion etc.) is determined so that the stay crushing process makes progress after the extension process and cross-section crushing process of the bumper reinforcing member 2 make progress.

Next, a process in which the bumper structure B1 absorbs collision energy will be explained by referring to FIG. 3.

When a collision load in a front-rear direction is applied to the bumper structure B1, as shown in FIG. 3B, first the collision energy is absorbed by the curved portion of the bumper reinforcing member 2 being extended rectilinearly between the bumper stays 1, 1 (extension process).

In a case when collision energy cannot be absorbed enough by the extension process only, the collision energy is further absorbed by the bumper stay 1 breaking into the bumper reinforcing member 2 as shown in FIG. 3C (cross-section crushing process). By making the bumper stay 1 break into the bumper reinforcing member 2 after the curved portion of the bumper reinforcing member is rectilinearly extended, a peak of collision load that propagates to the side member S during the extension process and a peak of collision load that propagates to the side member S during the cross-section crushing process (a process in which the bumper reinforcing member is crushed in a front-rear direction) appear with a time lag. During the cross-section crushing process, in a area adjacent to the bumper stay 1, a buckling or a plastic bending deformation occurs on the bumper reinforcing member main portion 21 shown in FIG. 2B, mainly on the upper wall 21a, lower wall 21b, and inner wall 22, which causes the internal space of the main portion 21 being crushed.

In a case when collision energy still cannot be absorbed completely even when the cross-section crushing process made progress, the collision energy is further absorbed by the bumper stay 1 itself being crushed in a front-rear direction (stay crushing process). If the bumper stay 1 is made crushed after the bumper stay 1 is made break into the bumper reinforcing member 2, a peak of collision load that propagates to the side member S during the cross-section crushing process and a peak of collision load that propagates to the side member S during the stay crushing process appear with a time lag. During the stay crushing process, in the bumper stay 1, a buckling or a plastic bending deformation occurs mainly on the exterior wall 12, interior wall 13, partition wall 15 and reinforcing wall 16, which causes the hollow spaces a, b, and c (see FIG. 2A) being crushed. In fact, in the stay crushing process in this embodiment, first a buckling or a plastic bending deformation occurs on the interior wall 13 and the reinforcing wall 16 of the bumper stay 1, whereby the hollow spaces b and c are crushed, then a buckling or a plastic bending deformation occurs on the partition wall 15, whereby the hollow space b is further crushed, and then a buckling or plastic bending deformation occurs on the exterior wall 12 and finally the hollow space a is crushed.

According to the bumper structure B1 explained above, since the bumper stays 1, 1 are not crushed in a front-rear direction during a process in which a curved portion of the bumper reinforcing member 2 is rectilinearly extended (a extension process), i.e. the interior wall 13 is not buckled during the extension process, a distance between the supporting points of the bumper reinforcing member 2 is narrowed not only in appearance but also materially.

If the wall thickness of the front wall 21c and back wall 21d of the bumper reinforcing member 2 is made small without any considerations, on one hand the weight saving of the bumper reinforcing member is realized but on the other hand the bending rigidity of the bumper reinforcing member 2 is reduced. Then the deformation resistance of the bumper reinforcing member 2 is lowered and the amount of absorption of collision energy is reduced. In contrast, according to the bumper structure B1 of the present invention, since the distance between the supporting points of the bumper reinforcing member 2 is narrowed by the bumper stay 1 having a shape widening toward the end, the deformation resistance of the bumper reinforcing member 2 is not lowered severely even when the wall thickness of the front wall 21c and back wall 21d of the bumper reinforcing member 2 is reduced for weight saving. Therefore, the amount of absorption of collision energy is not reduced severely during the extension process. In other words, according to the bumper structure B1, it is possible to reduce the wall thickness of the bumper reinforcing member 2 (in particular, the wall thickness of the front wall 21c and back wall 21d) without lowering the deformation resistance of the bumper reinforcing member 2 between the bumper stays 1, 1, which allows the weight saving without reducing the amount of absorption of collision energy during the extension process.

In fact, if the wall thickness of the bumper reinforcing member 2 is made equivalent to that in a case where the bumper reinforcing member is supported by bumper stays having a constant width, the deformation resistance of the bumper reinforcing member 2 between the bumper stays 1, 1 is increased compared to the case when supported by bumper stays having constant width, and consequently the amount of absorption of collision energy during the extension process is increased.

In addition, according to the bumper structure B1, since the peaks of collision load that propagate to the side member S during the extension process and the stay crushing process appear in series with a time lag, it is possible to keep the collision load by preventing a large reduction thereof after an increase thereof to the vehicle body.

Further, according to the bumper structure B1, using the bumper stay 1 formed in a shape widening toward the end, it is possible to increase a crushing area of the bumper reinforcing member 2 compared to a case when using a bumper stay that is not formed in a shape widening toward the end, and consequently to increase the absorbed amount of collision energy.

In addition, according to the bumper structure B1, since both the bumper stay 1 and bumper reinforcing member 2 are formed of an extruded member made of aluminum alloy, it is possible to reduce the weight and cost of the bumper structure B1, further facilitating the production, and providing the stable quality.

Structures of the bumper stay 1 and the bumper reinforcing member 2 may be changed as appropriate.

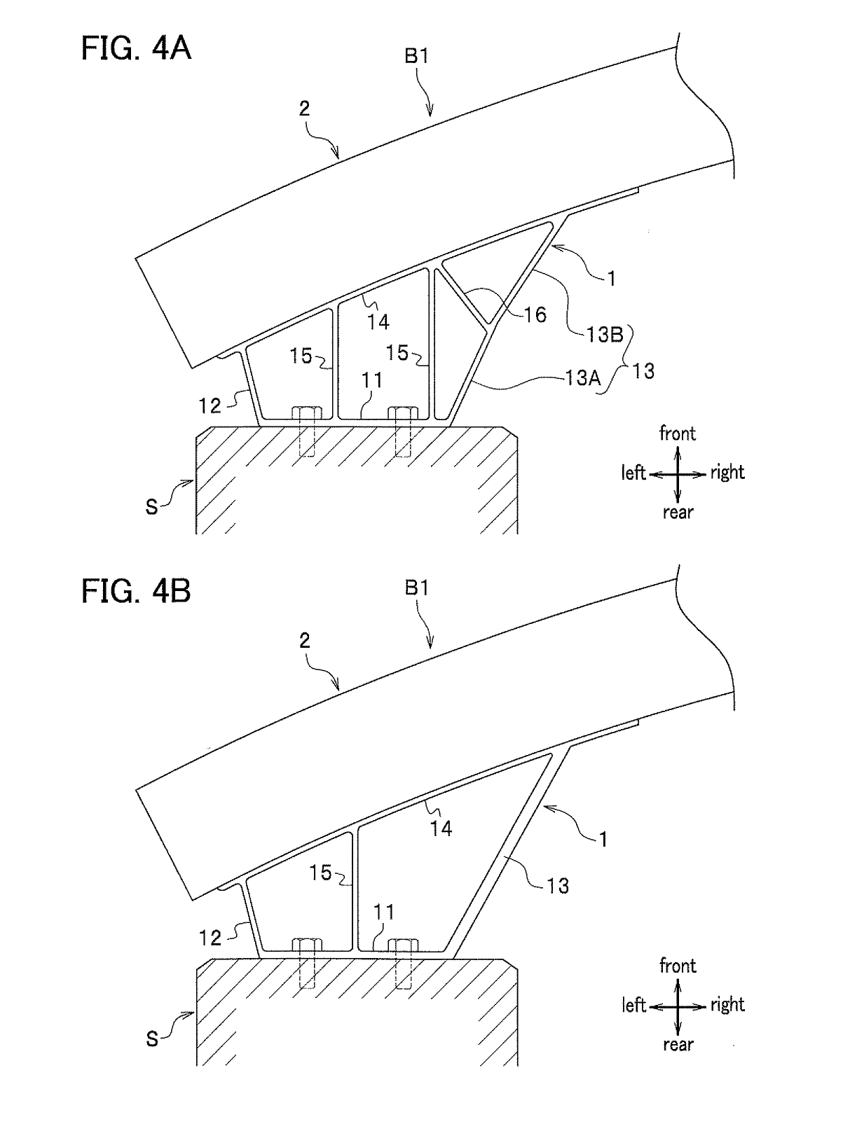

For example, the bumper stay 1 having one partition wall 15 is shown as an example in the embodiment above, but there may be two or more partition walls 15 as shown in FIG. 4A.

In the embodiment above, the reinforcing wall 16 is disposed to prevent the interior wall 13 from buckling during the extension process, but the interior wall 13 may be prevented from buckling during the extension process by making the wall thickness of the interior wall 13 larger than that of the other portions as shown in FIG. 4B. In this structure, the reinforcing wall 16 may be omitted.

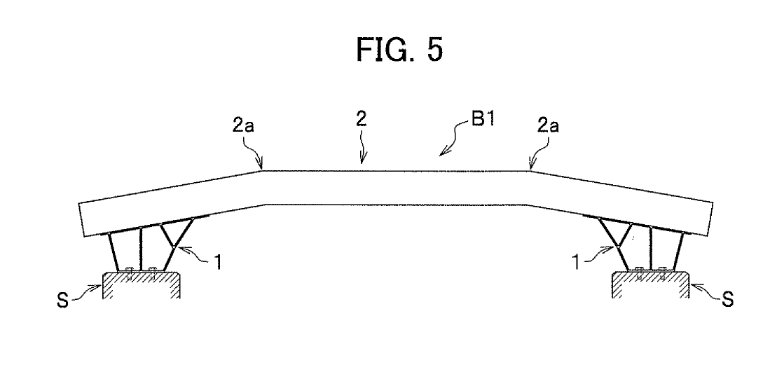

In the embodiment above, an example is shown in which the bumper reinforcing member 2 is formed in a shape of circular arc as a whole, but the bumper reinforcing member 2 may be formed in another shape having two bent portions 2a, 2a between the bumper stays 1, 1 as shown in FIG. 5. In this case, collision energy in the early stage of the collision is absorbed by the bent portions 2a, 2a of the bumper reinforcing member 2 being rectilinearly extended.

### Second Embodiment

In the first embodiment, the bumper stay 1 including the outside projecting portion 17 and the inside projecting portion 18 is shown as an example, but the outside projecting portion 17 and the inside projecting portion 18 may be omitted.

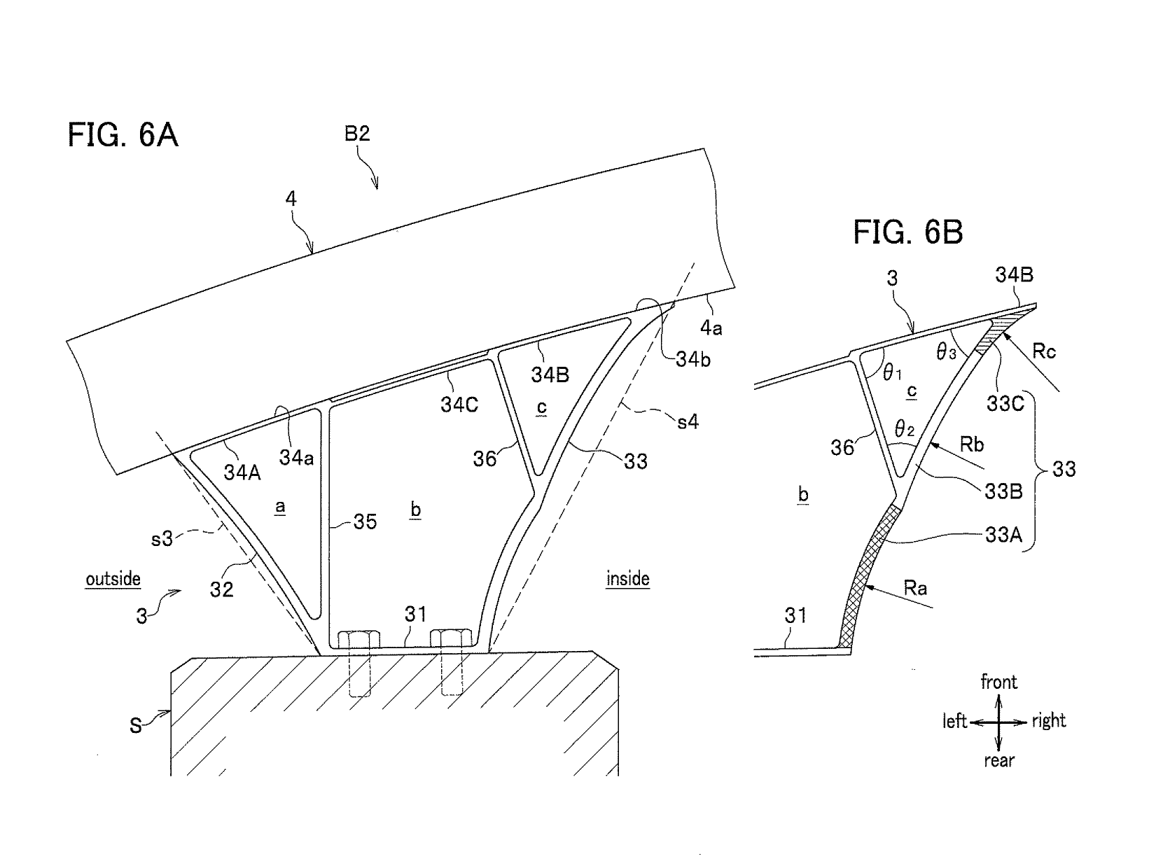

As shown in FIG. 6A, a bumper structure B2 in the second embodiment includes a bumper stay 3 without a projecting portion, and a bumper reinforcing member 4. Meanwhile, the bumper structure B2 is formed as a front bumper.

The bumper stay 3 is formed in a shape the width of which gradually increases from the side member S toward the bumper reinforcing member 4 (in a shape widening toward the end). The bumper stay 3 according to the embodiment includes a hollow extruded member having a closed cross-sectional hollow spaces a, b, c (hollow member) made of aluminum alloy, with the extruding direction of which being up and down direction. The hollow space a located outside in a vehicle width direction and the hollow space c located inside in a vehicle width direction are formed in a shape of triangle in a plan view, and the hollow space b located between the hollow spaces a and c is formed in a shape of pentagon in a plan view.

The structure of the bumper stay 3 will be explained in detail. The bumper stay 3 includes a base portion 31, a pair of sidewalls 32, 33, an outside fixing portion 34A, an inside fixing portion 34B, a coupling portion 34C, a partition wall 35, and a reinforcing wall 36.

The base portion 31 is a flat plate portion that is fixed on an anterior end surface of the side member S, and forms a part of an outer shell of the hollow space b. A bolt-hole is provided on an appropriate place of the base portion 31. A bolt is inserted to the bolt-hole for fixing the base portion 31 to the anterior end surface of the side member S.

The sidewall 32 located outside in the vehicle width direction is a portion extending from an end edge of the base portion 31 located outside in the vehicle width direction to an end edge of the outside fixing portion 34A located outside in the vehicle width direction, and supports the outside fixing portion 34A from the vehicle body. The sidewall 33 located inside in the vehicle width direction is a portion extending from an end edge of the base portion 31 located inside in the vehicle width direction to an end edge of the inside fixing portion 34B located outside in the vehicle width direction, and supports the outside fixing portion 34B from the vehicle body. The sidewalls 32, 33 are located so that the partition wall 35 is located therebetween, and facing to each other with a distance in the vehicle width direction. The offset distance of the sidewalls 32, 33 gradually increases from the side member S toward the bumper reinforcing member 4.

In a case where the sidewalls 32, 33 are to be distinguished from each other, the sidewall 32 located outside in the vehicle width direction may be referred to as “exterior wall 32”, and the sidewall 33 located outside in the vehicle width direction may be referred to as “interior wall 33”.

The exterior wall 32 forms a part of the hollow space a, and is attached obliquely to the base portion 31. The inner angle made by the base portion 31 and the exterior wall 32 forms a blunt angle. In addition, the exterior wall 32 is formed in a shape of circular arc in plan view and curves toward the internal space of the bumper stay 3 (toward the hollow space a). In other words, the exterior wall 32 is located closer to the hollow space a than a flat plane s3 which passes an end edge located outside in the vehicle width direction of the base portion 31 and an end edge located outside in the vehicle width direction of the outside fixing portion 34A. In this embodiment, the exterior wall 32 having a shape of circular arc in plan view is shown as an example, but it is not intended to limit the structure of the exterior wall 32. The structure may be changed to an exterior wall having a plurality of circular-arc-shaped portions, or a flat plate exterior wall.

The interior wall 33 is attached obliquely to the base portion 31. The inner angle defined by the base portion 31 and the interior wall 33 forms a blunt angle. The interior wall 33 curves toward the internal space of the bumper stay 3 (toward the hollow spaces b and c). In other words, the whole exterior wall 33 is located closer to the hollow spaces b and c than a flat plane s4 which passes an end edge located inside in the vehicle width direction of the base portion 31 and an end edge located inside in the vehicle width direction of the inside fixing portion 34B.

As shown in FIG. 6B, the interior wall 33 includes a plurality of circular-arc-shaped portions 33A, 33B, 33C. In the following explanation, the circular-arc-shaped portion 33A which is connected to the base portion 31 is referred to as “first circular arc portion 33A”, the circular-arc-shaped portion 33C which is connected to the inside fixing portion 34B is referred to as “third circular arc portion 33C”, and the circular-arc-shaped portion 33B which connects the first circular arc portion 33A and the third circular arc portion 33C is referred to as “second circular arc portion 33B”. Hatching is given in FIG. 6 for clarifying the area of the first circular arc portion 33A and the third circular arc portion 33C.

The first circular arc portion 33A is a portion extending from the end edge located inside of the base portion 31 in the vehicle width direction toward a connection to the reinforcing wall 36, and forms a part of the outer shell of the hollow space b. The first circular arc portion 33A has a shape of circular arc in plan view, and curves toward the hollow space b.

The second circular arc portion 33B is a portion extending from the anterior end of the first circular arc portion 33A toward the back-end of the third circular arc portion 33C, and forms a part of the outer shell of the hollow space c. The second circular arc portion 33B has a shape of circular arc in plan view, and curves toward the hollow space c. In addition, the second circular arc portion 33B and the third circular arc portion 33C are contiguously formed without a hitch, while the first circular arc portion 33A and the second circular arc portion 33B are contiguously formed with a bent portion (not having a tangent line in common).

The third circular arc portion 33C is a portion extending from the anterior end of the second circular arc portion 33B toward the end edge located inside in the vehicle width direction of the inside fixing portion 34B, and forms a part of the outer shell of the hollow space c. The third circular arc portion 33C has a shape of circular arc in plan view, and curves toward the hollow space c.

Although the magnitude relation among the radius Ra of the first circular arc portion 33A, the radius Rb of the second circular arc portion 33B, and the radius Rc of the third circular arc portion 33C is represented by Rb>Ra>Rc in this embodiment, it may be changed as appropriate. In addition, in this embodiment, three circular-arc-shaped portions 33A, 33B, 33C are explained as an example, but a structure of the interior wall 33 is not limited thereto. It may be changed to an interior wall having one circular-arc-shaped portion, or to an interior wall having a plane plate (not shown in the figure).

As shown in FIG. 6A, an outside fixing portion 34A and an inside fixing portion 34B are portions that are fixed to a side surface 4a of the bumper reinforcing member 4. The outside fixing portion 34A and the inside fixing portion 34B are disposed side by side with a distance therebetween in the vehicle width direction. An abutting face 34a of the outside fixing portion 34A and an abutting face 34b of the inside fixing portion 34B are so formed as to have a curved surface (circular arc surface) the curvature of which being the same as that of the side surface 4a of the bumper reinforcing member 4, and can be fitted to the side surface 4a of the bumper reinforcing member 4 by face-to-face contact.

The coupling portion 34C is a portion that connects the outside fixing portion 34A and the inside fixing portion 34B. The coupling portion 34C and the side surface 4a of the bumper reinforcing member 4 are facing to each other with a distance. In other words, the anterior surface of the coupling portion 34C is located lower than the abutting faces 34a and 34b, and does not contact the side surface 4a of the bumper reinforcing member 4.

The partition wall 35 is a portion that connects the base portion 31 and the outside fixing portion 34A. The partition wall 35 extends upward from the end located outside of the base portion 31 in the vehicle width direction toward the end located inside of the outside fixing portion 34A in the vehicle width direction, and reaches the end located inside of the outside fixing portion 34A in the vehicle width direction. The partition wall 35 has a flat plate shape and is attached vertically to the base portion 31.

The reinforcing wall 36 is a portion that connects the interior wall 33 and the inside fixing portion 34B. As shown in FIG. 6B, the reinforcing wall 36 forms a flat plate, and extends upward from the boundary of the first circular arc portion 33A and the second circular arc portion 33B toward the inside fixing portion 34B, and reaches the end located outside of the inside fixing portion 34B in the vehicle width direction.

The crushability of the hollow space a shown in FIG. 6A is dependent on a curvature (radius) of the exterior wall 32 as well as the wall thickness, length etc. of the exterior wall 32, the outside fixing portion 34A and the partition wall 35. For example, if the curvature of the exterior wall 32 is made smaller (i.e. the radius is made larger), the buckling load of the exterior wall 32 becomes larger and the crushability of the hollow space a becomes low. If the curvature of the exterior wall 32 is made larger (i.e. the radius is made smaller), the buckling load of the exterior wall 32 becomes smaller and the crushability of the hollow space a becomes high.

The crushability of the hollow space b is dependent on the radius of the first circular arc portion 33A as well as the wall thickness, length etc. of the base portion 31, the first circular arc portion 33A (see FIG. 6B), the coupling portion 34C, the partition wall 35 and the reinforcing wall 36, which surround the hollow space b. For example, if the radius of the first circular arc portion 33A is made larger, the buckling load of the first circular arc portion 33A becomes larger and the crushability of the hollow space b becomes low. If the radius of the first circular arc portion 33A is made smaller, the buckling load of the first circular arc portion 33A becomes smaller and the crushability of the hollow space b becomes high.

The crushability of the hollow space c shown in FIG. 6B is dependent on the radius of the second circular arc portion 33B and the third circular arc portion 33C as well as the wall thickness, length etc. of the second circular arc portion 33B, the third circular arc portion 33C, the inside fixing portion 34B and the reinforcing wall 36, which surround the hollow space c. For example, if the radius of the second circular arc portion 33B or the third circular arc portion 33C is made larger, the crushability of the hollow space c becomes low. If the radius of the second circular arc portion 33B or the third circular arc portion 33C is made smaller, the crushability of the hollow space c becomes high.

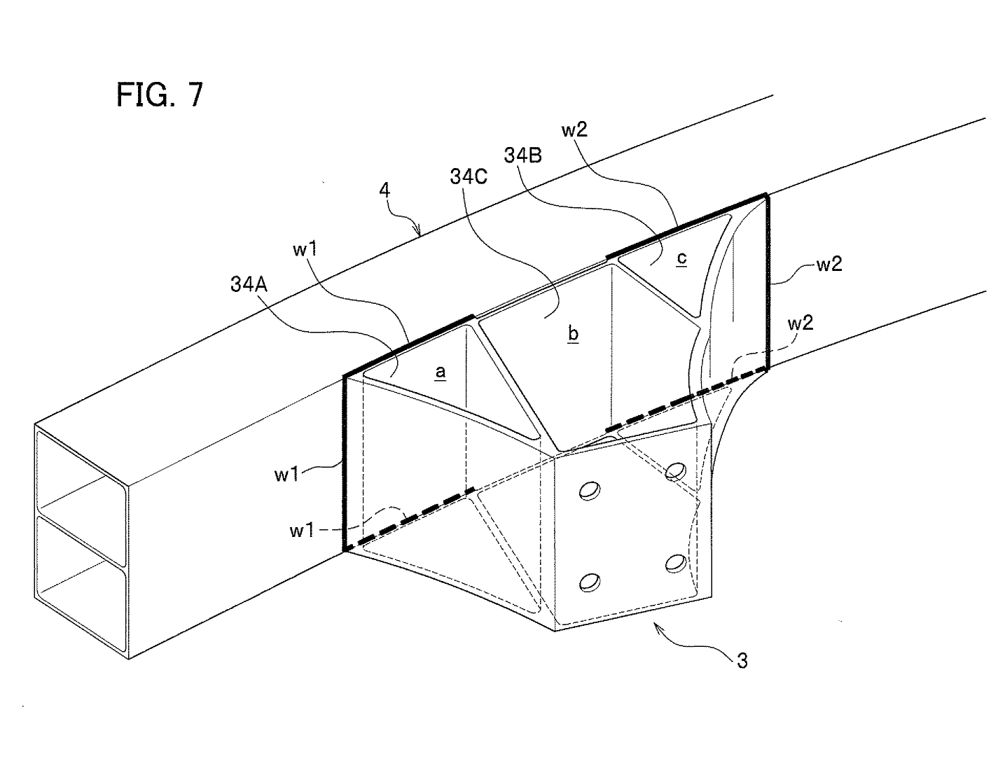

As shown in FIG. 7, the bumper stay 3 is fixed to the bumper reinforcing member 4 by applying welding w1 along the upper edge, lower edge, and the side edge located outside in the vehicle width direction of the outside fixing portion 34A, as well as applying welding w2 along the upper edge, lower edge, and the side edge located inside in the vehicle width direction of the inside fixing portion 34B. In other words, the bumper stay 3 is fixed to the bumper reinforcing member 4 via the outer shell of the hollow space a and the outer shell of the hollow space c.

Since the structure of the bumper reinforcing member 4 is the same as that of the bumper reinforcing member 2 in the first embodiment, the detailed explanation is omitted in this embodiment. Also in this embodiment, the bending rigidity of the entire bumper reinforcing member 4 is determined so that the cross-section crushing process makes progress after the extension process makes progress. In addition, in this embodiment, rigidity of the bumper stay 3 and the bumper reinforcing member 4 (a wall thickness and section size of each portion etc.) is determined so that the stay crushing process makes progress after the extension process and cross-section crushing process of the bumper reinforcing member 4 make progress.

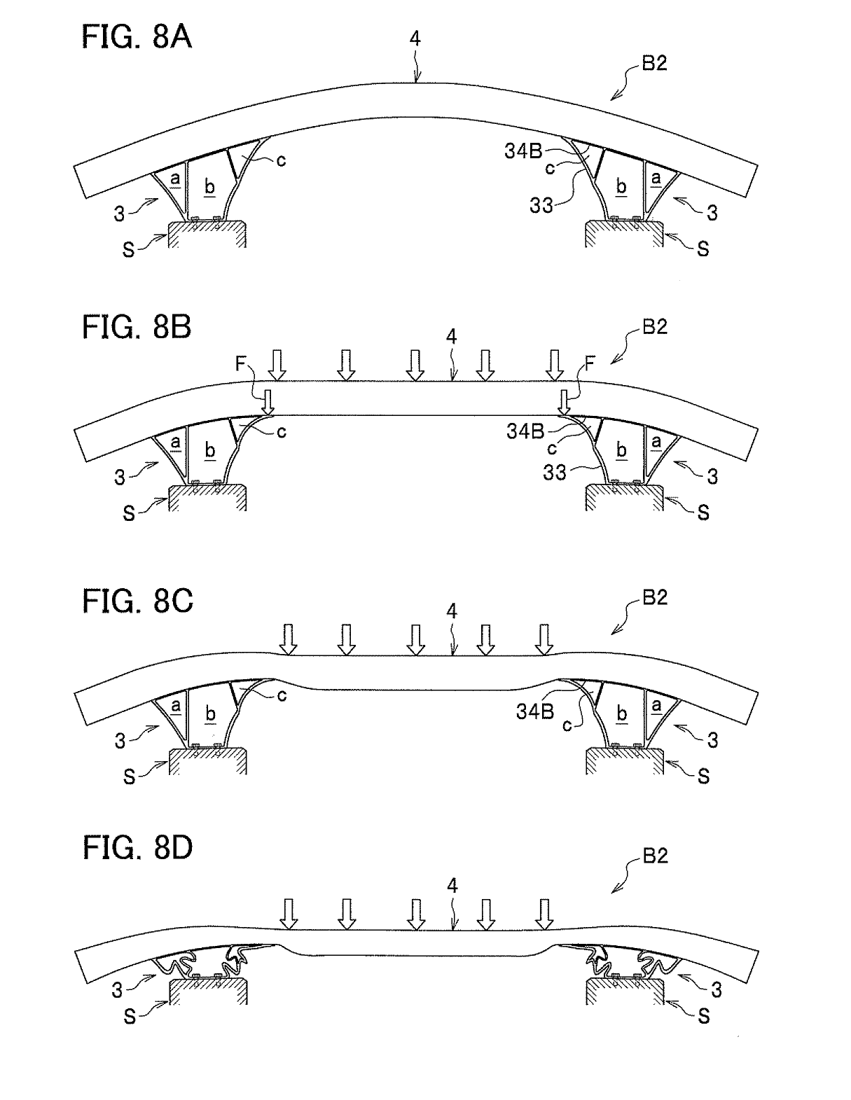

Next, a process of absorption of collision energy in head-on collision will be explained in reference to FIG. 8.

When a collision load from the front side (front of the vehicle) in a front-rear direction is applied to the bumper structure B2 shown in FIG. 8A, first the collision energy is absorbed by the curved portion of the bumper reinforcing member 4 being extended rectilinearly between the bumper stays 3, 3 as shown in FIG. 8B (extension process).

When the curved portion of the bumper reinforcing member 4 is extended rectilinearly, suppress strength F works on the bumper stay 3, which presses the outer shell of the hollow space c (the inside fixing portion 34B, the second circular arc portion 33B, third circular arc portion 33C and the reinforcing wall 36, shown in FIG. 6B) toward the vehicle body. However, since the outer shell of the hollow space c is in a shape of mechanically stabilized triangle in plan view, the bumper stay 3 supports the bumper reinforcing member 4 stably during the extension process. Here, since bending deformation occurs on the interior wall 33 and the inside fixing portion 34B during the extension process, although the initial shape of the outer shell of the hollow space c is not kept firmly, but the shape of the outer shell of the hollow space c during the extension process is basically kept in triangle in plan view. In other words, the outer shell of the hollow space c deforms appropriately so as not to disturb the extension of the reinforcing member 4, while supporting the bumper reinforcing member 4 stably.

When the extension process goes along to the final phase or goes to completion, the cross-section crushing process begins to make progress as shown in FIG. 8C. In the cross-section crushing process, collision energy is absorbed by the bumper stay 3 breaking into the bumper reinforcing member 4, and by the bumper reinforcing member 4 having cross-sectional deformation in progress in the region adjacent to the bumper stay 3 (i.e. the internal space of the bumper reinforcing member 4 is crushed). By making the bumper stay 3 break into the bumper reinforcing member 4 after the curved portion of the bumper reinforcing member 4 is rectilinearly extended, a peak of collision load that propagates to the side member S during an extension process and a peak of collision load that propagates to the side member S during a cross-section crushing process (a process where the bumper reinforcing member 4 is crushed in a front-rear direction) appear with a time lag.

If the bumper reinforcing member 4 is broken up by the edge of the bumper stay 3 when the bumper stay 3 breaks into the bumper reinforcing member 4, the amount of energy absorption in the cross-section crushing process is reduced. However, according to the bumper structure B2, the outer shell of the hollow space c is deformed appropriately, and therefore the bumper reinforcing member 4 is not easily broken up. More specifically, although the outer shell of the hollow space c breaks into the bumper reinforcing member 4 basically keeping a shape of triangle in plan view, since appropriate bending deformation occurs in the interior wall 33 and the inside fixing portion 34B, “breaking up” on the end edge located inside in the vehicle width direction of the inside fixing portion 34B does not occur easily, and therefore the bumper reinforcing member 4 is crushed widely.

If an angle θ₂ defined by the interior wall 33 and the reinforcing wall 36 is made smaller (see FIG. 6B), the outer shell of the hollow space c may become too robust while the bumper reinforcing member 4 can be supported stably. So, it is desirable to determine θ₂ in a range in which there is no fear of “breaking up” on the end edge located inside in the vehicle width direction of the inside fixing portion 34B. As shown in FIG. 6B, in this embodiment, the magnitude relation among angles θ₁ defined by the inside fixing portion 34B and the reinforcing wall 36, θ₂ defined by the interior wall 33 and the reinforcing wall 36, and θ₃ defined by the interior wall 33 and the inside fixing portion 34B is represented by θ₁>θ₂>θ₃. Under this relation, it is possible to support the bumper reinforcing member 4 stably while preventing the occurrence of “breaking up”.

When the cross-section crushing process goes along to the final phase or goes to completion, the stay crushing process begins to make progress as shown in FIG. 8D. In the stay crushing process, collision energy is absorbed by the bumper stay 3 being crushed in the front-rear direction. By making the bumper stay 3 crush after making the bumper stay 3 break into the bumper reinforcing member 4, a peak of collision load that propagates to the side member S during the cross-section crushing process and a peak of collision load that propagates to the side member S during the stay crushing process appear with time lags. In the stay crushing process, the hollow spaces a, b, and c are crushed by the occurrence of buckling or plastic bending deformation or the like on some portions such as the exterior wall 32, the interior wall 33, the partition wall 35, and the reinforcing wall 36 shown in FIG. 6A, of the bumper stay 3.

As the exterior wall 32 and the interior wall 33 of the bumper stay 3 are curved toward the internal space of the bumper stay 3, the buckling mode of the exterior wall 32 and the interior wall 33 is, in most cases, such that they buckle toward the internal space of the bumper stay 3. In other words, according to the bumper stay 3, a variance of the shape thereof during and after the crushing process can be small, and therefore a variance of the amount of absorption of collision energy in the stay crushing process can be small as well.

According to the bumper structure B2 explained above, at least in a case of head-on collision, the bumper stays 3, 3 do not crush in the front-rear direction during the extension process. In fact, in the bumper structure B2, a distance between the supporting points of the bumper reinforcing member 4 is narrowed not only in appearance but also materially.

In addition, in the bumper structure B2, it is possible to reduce the wall thickness of the bumper reinforcing member 4 without reducing the deformation resistance of the bumper reinforcing member 4 between the bumper stays 3, 3, and therefore weight saving can be achieved without a reduction in the amount of absorption of collision energy in the extension process.

In addition, according to the bumper structure B2, at least in a case of head-on collision, the extension process, the cross-section crushing process, and the stay crushing process make progress in series, which leads the peaks of collision load appear in series with time lags. Therefore, according to the bumper structure B2, it is possible to keep the collision load by preventing a large reduction thereof after increase thereof.

Further, according to the bumper structure B2, using the bumper stay 3 formed in a shape widening toward the end, it is possible to increase a crushing area of the bumper reinforcing member 4 compared to a case when using a bumper stay that is not formed in a shape widening toward the end, and consequently to increase the absorbed amount of collision energy.

In addition, according to the bumper structure B2, since both the bumper stay 3 and bumper reinforcing member 4 are formed of an extruded member made of aluminum alloy, it is possible to reduce the weight and cost of the bumper structure B2, further facilitating the production, and providing the stable quality.

### Third Embodiment

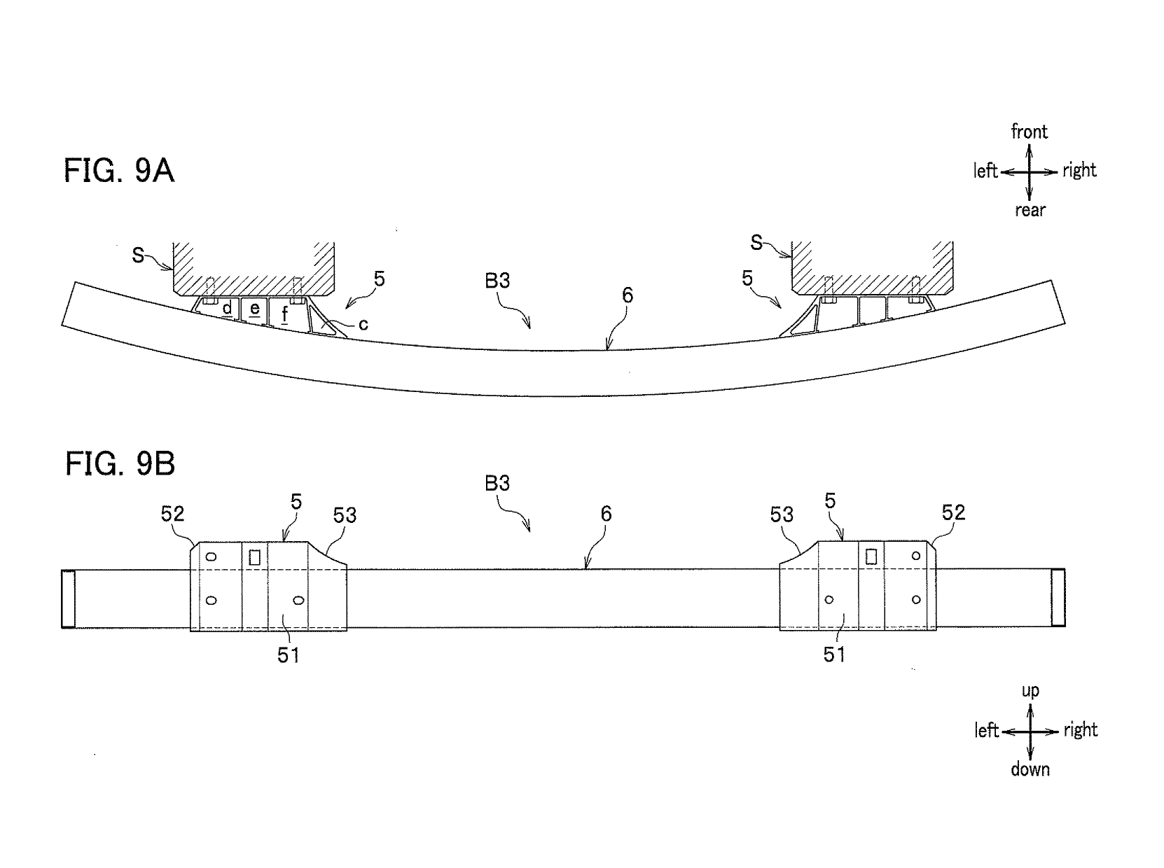

As shown in FIG. 9A, a bumper structure B3 in the third embodiment includes: bumper stays 5, 5 without a projecting portion; and a bumper reinforcing member 6. The bumper structure B3 is formed as a rear bumper.

The bumper stay 5 is formed in a shape the width of which gradually increases from the side member S toward the bumper reinforcing member 6 (in a shape widening toward the end). The bumper stay 5 includes an extruded member made of aluminum alloy having a closed cross-sectional hollow space c and open cross-sectional conduit spaces d, e, and f with the extruding direction of which being up and down direction. The hollow space c is formed in a shape of triangle in a plan view. As shown in FIG. 9B, the upper surface of the bumper stay 5 is cut at a slant, and the height of the bumper stay 5 gradually decreases from the side member S toward the bumper reinforcing member 6.

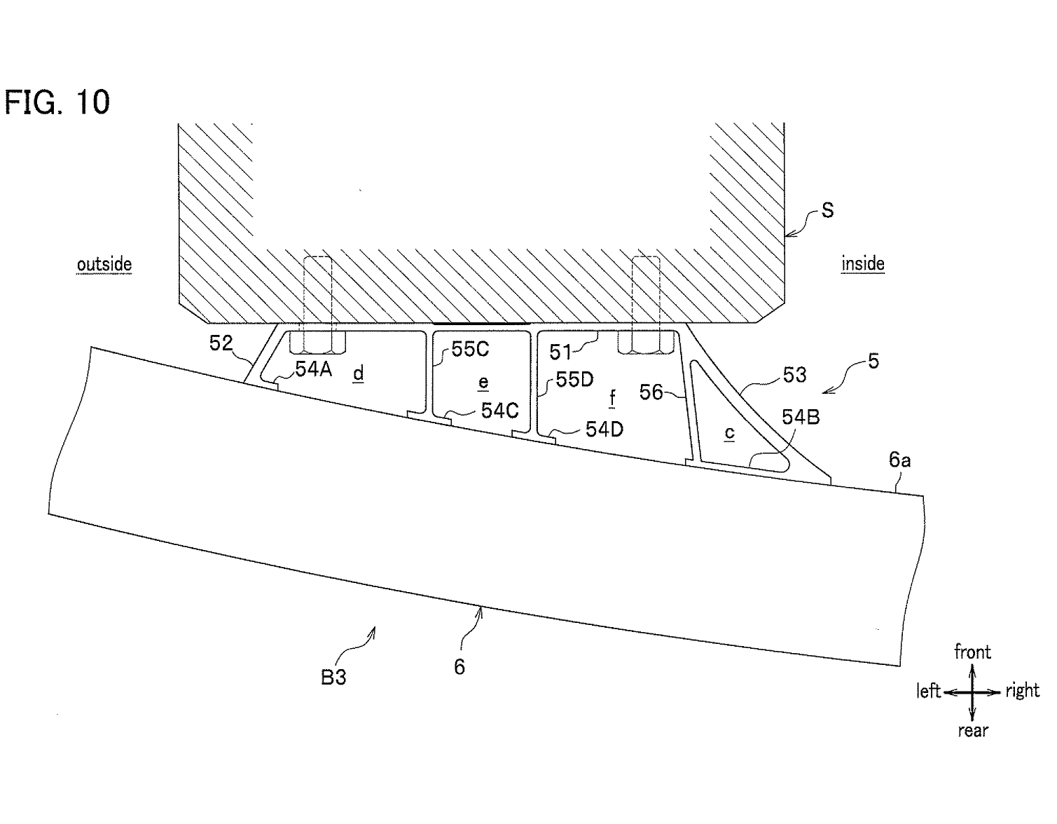

The structure of the bumper stay 5 will be explained in detail. As shown in FIG. 10, the bumper stay 5 includes a base portion 51, a pair of sidewalls 52,53, an outside fixing portion 54A, an inside fixing portion 54B, middle fixing portions 54C, 54D, partition walls 55C, 55D, and a reinforcing wall 56.

The base portion 51 is a flat plate portion fixed to the back-end surface of the side member S. A bolt-hole is provided on an appropriate place of the base portion 51.

The sidewall 52 located outside in the vehicle width direction is a portion extending from an end edge of the base portion 51 located outside in the vehicle width direction to an end edge of the outside fixing portion 54A located outside in the vehicle width direction, and supports the outside fixing portion 54A from the vehicle body. The sidewall 53 located inside in the vehicle width direction is a portion extending from an end edge of the base portion 51 located inside in the vehicle width direction to an end edge of the inside fixing portion 54B located outside in the vehicle width direction, and supports the outside fixing portion 54B from the vehicle body. The sidewalls 52, 53 are located so that the partition walls 55C, 55D are located therebetween, and the sidewalls 52 and 53 are facing to each other with a distance in the vehicle width direction. The offset distance of the sidewalls 52, 53 gradually increases from the side member S toward the bumper reinforcing member 6.

In a case where the sidewalls 52, 53 are to be distinguished from each other, the sidewall 52 located outside in the vehicle width direction may be referred to as “exterior wall 52”, and the sidewall 53 located inside in the vehicle width direction may be referred to as “interior wall 53”.

The exterior wall 52 is attached obliquely to the base portion 51. The inner angle made by the base portion 51 and the exterior wall 52 forms a blunt angle.

The interior wall 53 is attached obliquely to the base portion 51. The inner angle defined by the base portion 51 and the interior wall 53 forms a blunt angle. The interior wall 53 is in a shape of circular arc and curves toward the internal space of the bumper stay 5 (toward the hollow space c).

The outside fixing portion 54A, the inside fixing portion 54B and the middle fixing portions 54C, 54D are portions fixed to the side surface 6a located at a vehicle body side of the bumper reinforcing member 6, and are disposed side by side with a distance therebetween in the vehicle width direction. The outside fixing portion 54A, the inside fixing portion 54B and the middle fixing portions 54C, 54D can be fitted to the side surface 6a of the bumper reinforcing member 6 by face-to-face contact.

The partition walls 55C, 55D are portions vertically extending from a middle portion of the base portion 51 in the vehicle width direction to the middle fixing portions 54C, 54D, and support the middle fixing portions 54C, 54D.

The reinforcing wall 56 is a portion that connects the interior wall 53 and the inside fixing portion 54B. The reinforcing wall 56 in the embodiment forms a flat plate, and extends upward from the boundary of the base portion 51 and the interior wall 53 toward the inside fixing portion 54B, and reaches the end located outside of the inside fixing portion 54B in the vehicle width direction.

Also in this embodiment, rigidity of the bumper stay 5 and the bumper reinforcing member 6 (a wall thickness and section size of each portion etc.) is determined so that the stay crushing process makes progress after the extension process and the cross-section crushing process of the bumper reinforcing member 6 make progress.

When a collision load from the front side (rear of the vehicle) in a front-rear direction is applied to the bumper structure B3 (not shown in a figure), first the collision energy is absorbed by the curved portion of the bumper reinforcing member 6 being extended rectilinearly between the bumper stays 5, 5 (extension process).

Here, although a planar shape of the outer shell of the hollow space c is not kept firmly, the shape of the outer shell of the hollow space c during the extension process is basically kept in triangle in plan view. In other words, the outer shell of the hollow space c deforms appropriately so as not to disturb the extension of the reinforcing member 6, while supporting the bumper reinforcing member 6 stably.

In a case when collision energy cannot be absorbed enough by the extension process only, collision energy is further absorbed by the bumper stay 5 breaking into the bumper reinforcing member 6 and the bumper reinforcing member 6 making a cross-sectional deformation, i.e. the internal space of the bumper reinforcing member 6 is crushed (cross-section crushing process). If collision energy still cannot be absorbed completely even when the cross-section crushing process made progress, the collision energy is further absorbed by the bumper stay 5 itself being crushed in a front-rear direction (stay crushing process).

According to the bumper structure B3 explained above, since the bumper stays 5, 5 are not crushed in a front-rear direction at least during the collision from the rear face of the vehicle (hereinafter simply referred to as “head-on collision”). That means, according to the bumper structure B3, the distance between the supporting points of the bumper reinforcing member 6 is narrowed not only in appearance but also materially.

In other words, according to the bumper structure B3, it is possible to reduce the wall thickness of the bumper reinforcing member 6 without lowering the deformation resistance of the bumper reinforcing member 6 between the bumper stays 5, 5, allowing the weight saving without reducing the amount of absorption of collision energy.

In addition, according to the bumper structure B3, at least in a case of head-on collision, the extension process, the cross-section crushing process, and the stay crushing process make progress in series, the peaks of collision load appear in series with time lags. Therefore, according to the bumper structure B3, it is possible to keep the collision load by preventing a large reduction thereof after an increase thereof.

Further, according to the bumper structure B3, using the bumper stay 5 formed in a shape widening toward the end, it is possible to increase a crushing area of the bumper reinforcing member 6 compared to a case when using a bumper stay that is not formed in a shape widening toward the end, and consequently to increase the absorbed amount of collision energy.

In addition, according to the bumper structure B3, since both the bumper stay 5 and bumper reinforcing member 6 are formed of an extruded member made of aluminum alloy, it is possible to reduce the weight and cost of the bumper structure B3, further facilitating the production, and providing the stable quality.

1. A bumper structure, comprising:
a left and right pair of bumper stays fixed to a vehicle body; and
a bumper reinforcing member supported by both the bumper stays;
wherein each bumper stay is formed in a shape a width of which gradually increases from the vehicle body toward the bumper reinforcing member,
the bumper reinforcing member is bent or curved in between the bumper stays,
rigidity of the bumper stays and the bumper reinforcing member is determined so that the bumper stays are crushed in a front-rear direction after a bent portion or a curved portion of the bumper reinforcing member is rectilinearly extended.

2. A bumper structure, comprising:
a left and right pair of bumper stays fixed to a vehicle body; and
a bumper reinforcing member supported by both the bumper stays;
wherein each bumper stay has a pair of sidewalls facing to each other with a distance in a vehicle width direction and an offset distance between the sidewalls gradually increases from the vehicle body toward the bumper reinforcing member,
the bumper reinforcing member is bent or curved in between the bumper stays, and
rigidity of the bumper stays and the bumper reinforcing member is determined so that the sidewall that is located inside in a vehicle width direction is buckled after a bent portion or a curved portion of the bumper reinforcing member is rectilinearly extended.

3. The bumper structure according to claim 2, wherein the sidewall that is located inside in the vehicle width direction has a portion curved toward an internal space of the bumper stay.

4. The bumper structure according to claim 2, wherein
each bumper stay has a fixing portion abutting on the bumper reinforcing member and a reinforcing wall extending from the sidewall located inside in the vehicle width direction toward the fixing portion, and
a hollow space having a triangular shape in a plan view is formed by the sidewall located inside in the vehicle width direction, the fixing portion and the reinforcing wall.

5. The bumper structure according to claim 1, wherein the rigidity of the bumper reinforcing member and the bumper stays is determined so that the bumper stays break into the bumper reinforcing member after the bent portion or the curved portion of the bumper reinforcing member is rectilinearly extended.

6. The bumper structure according to claim 5, wherein the rigidity of the bumper reinforcing member and the bumper stays is determined so that the bumper stays are crushed after the bumper stays break into the bumper reinforcing member.

7. The bumper structure according to claim 1 or claim 2, wherein at least one of the bumper reinforcing member and the bumper stay is formed of an extruded member made of aluminum alloy.
